(19) United States
(12) Patent Application Publication
(10) Pub. No.: US 2025/0259258 A1
(43) Pub. Date: Aug. 14, 2025

(54) GRAPHICS PROCESSING SYSTEMS

(71) Applicant: Arm Limited, Cambridge (GB)

(72) Inventors: Maochang Dang, Shanghai (CN); Espen Amodt, Shanghai (CN); Daren Croxford, Swaffham Prior (GB)

(21) Appl. No.: 18/438,193

(22) Filed: Feb. 9, 2024

(51) Int. Cl. G06T 1/20

(52) U.S. Cl. CPC G06T 1/20

(57) ABSTRACT

Graphics processing unit and methods are provided that substantially remove, or reduce, latencies in rendering a sequence of frames for extended Reality (XR) by implementing a predict token, wherein the predict token is indicative of an extrapolated or interpolated target frame to be generated for the sequence of frames.

The technology described herein relates to graphics processing systems, and in particular to graphics processing units that provide images for display for extended Reality (XR), wherein XR can encompass Virtual Reality (VR), Augmented Reality (AR) and/or Mixed Reality (MR).

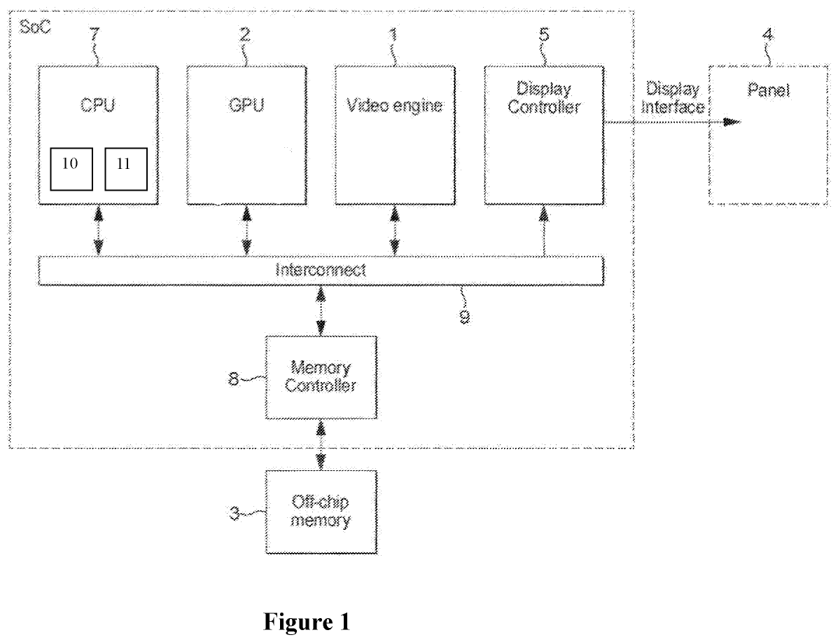

FIG. 1 shows an exemplary system on chip (SoC) graphics processing system that comprises a host processor (e.g. a Central Processing Unit (CPU)) 7, a graphics processing unit (GPU) 2, a display controller 5, and a memory controller 8. The exemplary graphics processing system may also comprise a video engine 1. As shown in FIG. 1, these units communicate via an interconnect 9 and have access to off-chip memory 3 via the memory controller 8. In this system, the graphics processing unit (GPU) 2 will render frames (images) to be displayed, and the display controller 5 will then provide the frames to a display panel 4 for display via a display interface.

In use of this system, an application 10 such as a game, executing on the host processor (CPU) 7 will, for example, require the display of frames on the display 4. To do this, the application 10 will submit appropriate commands and data to a driver 11 for the graphics processing unit (GPU) 2 that is executing on the CPU 7. The driver 11 will then generate appropriate commands and data to cause the graphics processing unit (GPU) 2 to render appropriate frames for display and to store those frames in appropriate frame buffers, e.g. in the off-chip memory 3. The display controller 5 will then read those frames which can subsequently be displayed on a display panel of the display 4.

The graphics processing system is operable to provide frames for display, and the graphics processing unit (GPU) 2 will correspondingly be operable to render frames, at an appropriate rate, such as 30 frames per second.

An example of a use of a graphics processing system such as that illustrated in FIG. 1 are XR systems, which provide an extended reality (XR) output, for example, to a head mounted display (HMD), a mobile device display, or any other suitable device display for displaying XR frames (images). In the graphics processing system, appropriate frames (images) to be displayed will be rendered by the graphics processing unit (GPU) 2 in response to appropriate commands and data from the application, such as a game, (e.g. executing on the CPU 7) that requires the frames (images) to be displayed.

In such XR systems, it can be problematic to obtain, for example, a low latency and a high framerate. In terms of latency, when rendering frames that require processing operations, such as Asynchronous Time Warp (ATW), Asynchronous Space Warp (ASW), Asynchronous Reprojection (ARP), Translation, Lens Matched Shading (LMS), Variable Rate Shading (VRS), Fragment Density Map (FDM), Foveated Rendering, Partial Frame Processing, Motion Estimation and Optical Flow, Super Resolution, Framerate Upscaling, or any other required processing, or rendering, it traditionally requires several operations to be performed by the host processor (CPU), thereby suffering from a CPU-GPU roundtrip latency and context pre-emption In the traditional approach, more than one context would be required meaning a plurality of context switches, which requires context pre-emption, would need to be performed which introduces a significant latency, in particular in XR display systems.

As such, the traditional approach includes a significant latency, e.g. due to the CPU-GPU roundtrip and context pre-emption, which is detrimental to the performance of XR displays as latencies in rendering one or more frames can cause a user, viewing the XR display, to see anomalies or lack of smoothness (e.g. motion judder) in the rendered images on the display, or induce motion sickness for the viewing user, along with other problems and drawbacks associated with the induced latency in the traditional approach. Furthermore, the additional processing and memory access operations required by the application executing on the host processor (CPU) can increase the memory and power requirements which is problematic in relation to mobile devices and HMD systems. For example, in mobile display and HMD systems, limitations in one or more of the processing capabilities of the host processor CPU, (wherein the host processor (CPU) may use a complex operating system which will typically have an inherent latency), the application executing on the host processor (CPU), graphics processing unit (GPU) 2, the memory transaction capabilities of the graphics processing system and the (e.g. head-mounted or mobile device) display system for sending rendered frames for display, the energy storage (e.g. battery) and cooling capacities of the (e.g. head-mounted or mobile device) display system (which may, for example, be affected by the amount of memory transactions performed), may not allow frames to be rendered sufficiently and degrade the user's XR experience.

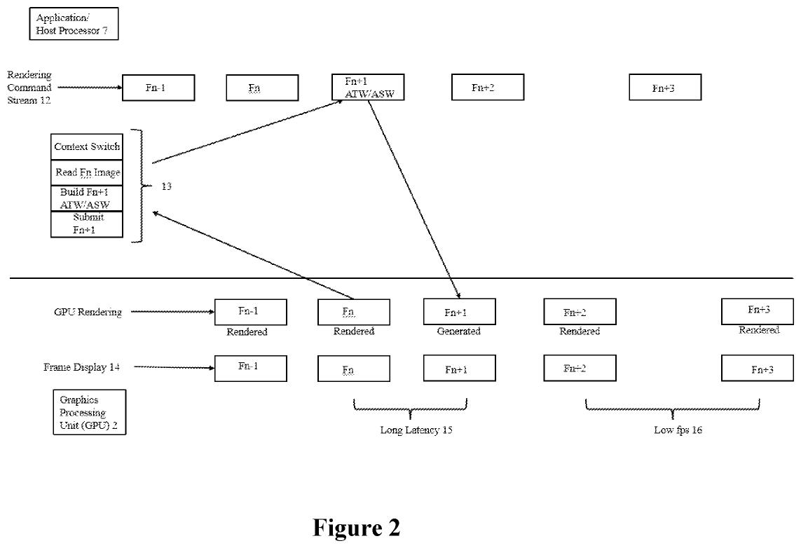

The traditional approach is shown in FIG. 2. The application 10 executing on the host processor (CPU) 7 submits the appropriate commands and data to a rendering command stream 12 for the graphics processing unit (GPU) 2, which cause the graphics processing unit (GPU) 2 to render appropriate frames for display. Frames n−1 and n are subsequently rendered by the graphics processing unit (GPU) based on the submitted commands and data in the rendering command stream 12. However, in the example of FIG. 2, target frame Fn+1 requires ATW and/or ASW processing operations to generate frame Fn+1 which traditionally requires the application executing on the CPU to perform several operations 13, for example, a context switch and context pre-emption, a read of the previous frame (Fn), a build the target frame Fn+1 ATW/ASW command, and a submission of the frame Fn+1 ATW/ASW command and data to the driver for the GPU, in order to enable the GPU to subsequently process to generate target frame Fn+1. In other words, as frame Fn+1 is dependent on frame Fn and the generation of frame Fn+1 requires the additional processing, or operations, in order to generate frame Fn+1, the application executing in the host processor (CPU) cannot provide the complete frame rendering commands and data in the rendering command stream 12 in advance of frame Fn being rendered and requires the host processor (CPU) to perform one or more operations 13. Thus, the CPU-GPU roundtrip and one or more operations performed by the application executing on the CPU introduces a significant latency 15 which can affect the display of the rendered frames to the user 14. As will be appreciated and understood, FIG. 2 is an example showing a frame Fn+1 requiring ATW/ASW operations, however, the same problems and drawbacks are equally applicable in the case the Frame n+1 requires other, or further, operations, such as those listed previously.

Furthermore, modern display systems and applications, e.g. computer games, can have a high frame rate (frames per second (fps)) requirement, e.g. greater than 120 fps, which is typically hard to achieve in conventional systems and approaches due to host processor (CPU) processing capability, graphics processing unit (GPU) processing capability, memory bandwidth, and/or limited power availability, e.g. for mobile devices and/or headsets, which cannot therefore achieve the required frame rate due to a heavy rendering overload to render each and every frame at high frame rates. Thus, as can be seen in FIG. 2, there can be a low frame rate (fps) 16 due to this problem.

The Applicants believe therefore that there remains scope for improvements to display operations in data processing systems, and, in particular, to graphics processing systems that provide images for display for extended reality (XR) display systems, e.g. head mounted displays, mobile devices, and so on.

According to a first aspect of the present disclosure there is provided a method of operating a graphics processing unit that renders a sequence of frames, the method comprising: receiving a predict token via a rendering command stream for the graphics processing unit, wherein the predict token is indicative of an extrapolated or interpolated target frame to be generated for the sequence of frames; executing the predict token; generating the target frame for the sequence of frames based on the execution of the predict token; and storing the generated target frame in a frame buffer.

In embodiments, the predict token may be generated by an application executing on a host processor (CPU), wherein the application may submit the predict token, in embodiments via a driver for the graphics processing unit, to a rendering command stream for the graphics processing unit. Alternatively, or additionally, to the application generating and submitting the predict tokens to the rendering command stream, the driver may generate and submit the predict tokens, or any other suitable firmware and/or software.

In embodiments the predict token may reference a predict command buffer, wherein the predict command buffer may include one or more predict commands defining one or more operations relating to the target frame to be generated by the graphics processing unit; and a predict parameter buffer, wherein the predict parameter buffer may include one or more parameters that store data relating to the target frame to be generated by the graphics processing unit.

In embodiments, executing, by the graphics processing unit, the predict token, may further comprise executing the one or more predict commands of the predict command buffer and populating one or more parameters of the predict parameter buffer based on one or more results of the execution of the one or more predict commands.

In embodiments, the one or more operations may include one or more of Motion Vector Estimation MVE, Asynchronous Reprojection ARP, Asynchronous Time Warp ATW, Asynchronous Space Warp ASW, Lens Matched Shading LMS, Variable Rate Shading VRS, Fragment Density Map FDM, Foveated Rendering, and Optical Flow Estimation.

In embodiments, the method may further comprise identifying, by the graphics processor unit, a predict frame generation type of the target frame to be generated, wherein the predict frame generation type may include extrapolation and/or interpolation; and generating, by the graphics processor unit, the target frame according to the identified predict frame generation type.

In embodiments, if the predict frame generation type is identified as extrapolation, the target frame may be generated based on a first frame of the sequence of frames and a second frame of the sequence of frames, wherein the first frame and the second frame may precede the target frame.

In embodiments, if the predict frame generation type is identified as interpolation, the target frame may be generated based on a first frame of the sequence of frames and a second frame of the sequence of frames, wherein the first frame may precede the target frame and the second frame may be subsequent to the target frame.

In embodiments, the one or more parameters of the predict parameter buffer may include one or more of a motion vector, a translation, a position difference, a rotation, a zoom in/out, a reprojection, a shift, and a 3D estimation.

According to a second aspect of the present disclosure there is provided a graphics processing unit operable to render a sequence of frames; wherein the graphics processing unit is operable to: receive a predict token via a rendering command stream for the graphics processing unit, wherein the predict token is indicative of an extrapolated or interpolated target frame to be generated for the sequence of frames; execute the predict token; generate the target frame for the sequence of frames based on the execution of the predict token; and store the generated target frame in a frame buffer.

In embodiments, the predict token may be generated by an application executing on a host processor (CPU), wherein the application may submit the predict token, in embodiments via a driver for the graphics processing unit, to a rendering command stream for the graphics processing unit. Alternatively, or additionally, to the application generating and submitting the predict tokens to the rendering command stream, the driver may generate and submit the predict tokens, or any other suitable firmware and/or software.

In embodiments, the predict token may reference a predict command buffer, wherein the predict command buffer may include one or more predict commands defining one or more operations relating to the target frame to be generated by the graphics processing unit; and a predict parameter buffer, wherein the predict parameter buffer may include one or more parameters that store data relating to the target frame to be generated by the graphics processing unit.

In embodiments, the graphics processing unit may be further operable to execute the one or more predict commands and to populate one or more parameters of the predict parameter buffer based on one or more results of the execution of the one or more predict commands.

In embodiments, the one or more operations may include one or more of Motion Vector Estimation MVE, Asynchronous Reprojection ARP, Asynchronous Time Warp ATW, Asynchronous Space Warp ASW, Lens Matched Shading LMS, Variable Rate Shading VRS, Fragment Density Map FDM, Foveated Rendering, and Optical Flow Estimation.

In embodiments, the graphics processor unit may be operable to identify a predict frame generation type of the target frame to be generated, wherein the predict frame generation type may include extrapolation and/or interpolation; and generate the target frame according to the identified predict frame generation type.

In embodiments, if the predict frame generation type is identified as extrapolation, the graphics processing unit may be operable to generate the target frame based on a first frame of the sequence of frames and a second frame of the sequence of frames, wherein the first frame and the second frame may precede the target frame.

In embodiments, if the predict frame generation type is identified as interpolation, the graphics processing unit may be operable to generate the target frame based on a first frame of the sequence of frames and a second frame of the sequence of frames, wherein the first frame may precede the target frame and the second frame may be subsequent to the target frame.

In embodiments, the one or more parameters of the predict parameter buffer may include one or more of a motion vector, a translation, a position difference, a rotation, a zoom in/out, a reprojection, a shift, and a 3D estimation.

In embodiments, the graphics processing unit may further comprise a command stream frontend, wherein the command stream frontend includes a hardware interface, the command stream frontend is operable to receive an instruction relating to an execution of the predict token; and execute in hardware the received instruction to generate the target frame based on the predict token.

In embodiments, the graphics processing unit may further comprise a command stream frontend, wherein the command stream frontend includes a micro-controller unit, the command stream frontend is operable to receive an instruction relating to an execution of the predict token; and execute in software the received instruction to generate the target frame based on the predict token.

According to a third aspect of the present disclosure there is provided a method of generating a predict token, comprising: generating a predict command buffer, wherein the predict command buffer include one or more commands for generating a target frame for the sequence of frames; generating a predict parameter buffer, wherein the predict parameter buffer includes one or more parameters for generating a target frame for the sequence of frames; including one or more instructions that include a reference to a memory location of the generated predict command buffer and the generated predict parameter buffer in the predict token; and submitting the generated predict token to a rendering command stream for a graphics processing unit.

In embodiments, the method may further comprise determining one or more performance requirements; monitoring the performance requirements; and generating the predict token based on the monitored performance requirements.

According to a fourth aspect of the present disclosure there is provided a non-transitory computer readable storage medium storing computer software code which when executing on a data processor performs a method of operating a graphics processing system according to one or more features of the first aspect and/or third aspect.

According to a fifth aspect of the present disclosure there is provided a graphics processing system comprising: a host processor; a graphics processing unit operable to render a sequence of frames; and an application and/or a driver executing on the host processor, wherein the application and/or is operable to submit a predict token to a rendering command stream for the graphics processing unit, wherein the predict token is indicative of an extrapolated or interpolated target frame to be generated for the sequence of frames; wherein the graphics processing unit is operable to: execute the predict token; generate the target frame for the sequence of frames based on the execution of the predict token; and store the generated target frame in a frame buffer.

According to a sixth aspect of the present disclosure there is provided a device comprising a graphics processing unit according to one or more features of the second aspect and/or the graphics processing system according to one or more features of the fifth aspect.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

One or more embodiments of the present disclosure will now be described, by way of example only, and with reference to the accompanying drawings, in which:

FIG. 1 shows an exemplary graphics processing system, according to one or more embodiments of the present disclosure.

FIG. 2 shows a traditional approach for rendering a sequence of frames by a graphics processing system.

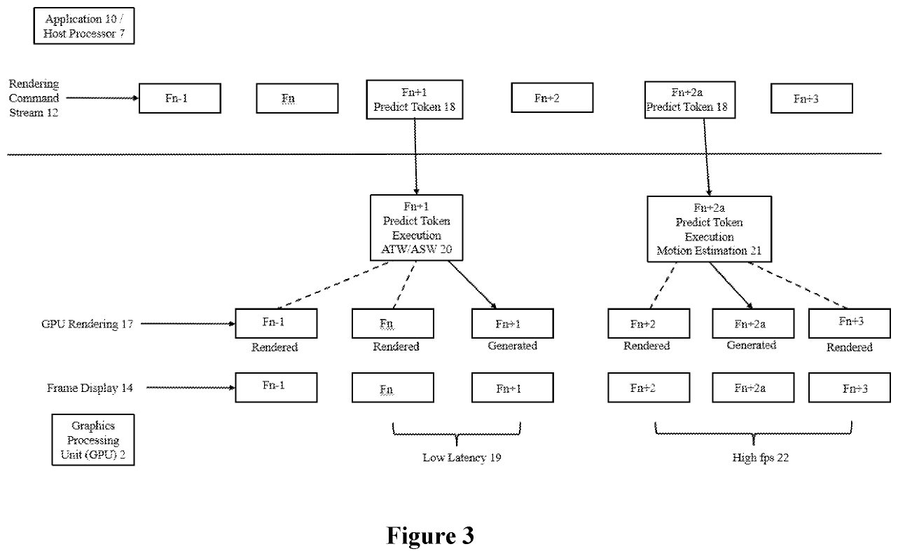

FIG. 3 shows an exemplary arrangement according to one or more embodiments of the present disclosure.

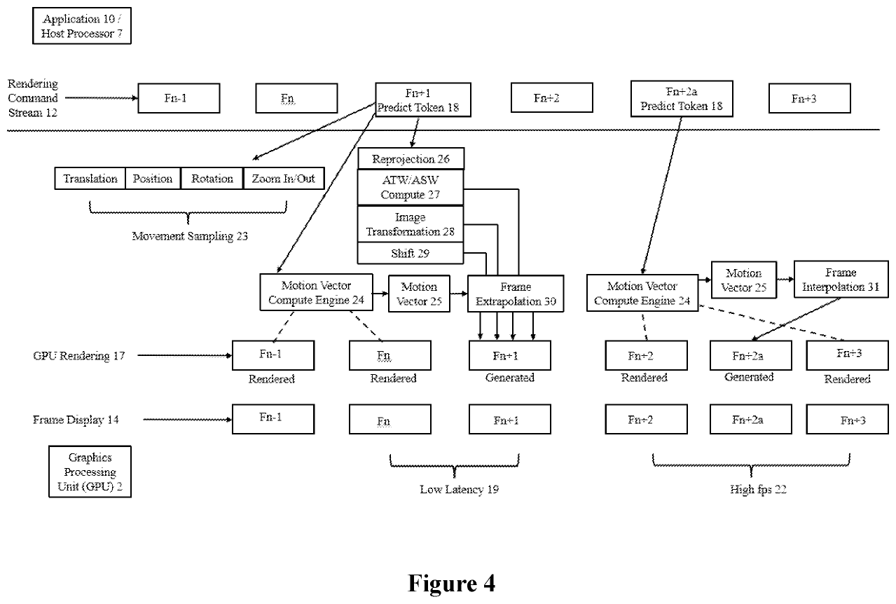

FIG. 4 shows an exemplary arrangement according to one or more embodiments of the present disclosure.

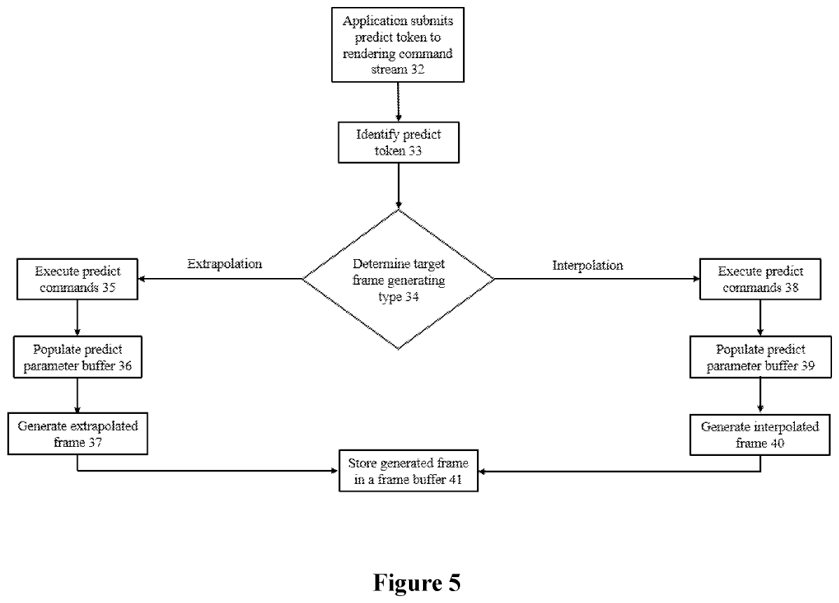

FIG. 5 is a flowchart showing schematically the operation of a graphics processing system according to one or more embodiments of the present disclosure.

The technology described herein relates to a graphics processing system that generates, or defines, a predict token for a graphics processing unit (GPU) driven rendering of frames in graphics processing systems that provide images for display for extended Reality (XR).

The graphics processing unit can include, and in embodiments does include, any one or more, and in embodiments all, of the processing stages that a graphics processing unit can normally include. Thus, for example, in an embodiment the graphics processing unit includes a primitive setup stage, a programmable execution unit operable to execute (shader) programs to perform processing operations, a rasteriser and a renderer (wherein the rendering approach may include, for example, raytracing, hybrid raytracing, or any other suitable rendering approach). In embodiments the renderer is in the form of, or includes, a programmable fragment shader. The graphics processor may otherwise be configured and operable as desired, and be operable to execute any suitable and desired form of graphics processing pipeline (in its normal graphics processing operation). Graphic processors and graphics processing is well known in the art and as such will not be described herein in detail.

Utilising a predict token advantageously enables an ultralow latency, low bandwidth, and low power graphics rendering, compared to the traditional approach, for graphics processing systems that provide images for display for extended Reality (XR). The predict token based graphics processing system is preferably implemented as an Application Programming Interface (API) extension in the driver for the graphics processing unit (GPU).

The predict token is preferably generated by the application executing on the host processor (CPU), the host processor (CPU), a driver for the GPU executing on the host processor (CPU), and/or a combination operating cooperatively (e.g. a combination of the application and the driver operating together), wherein the generated predict token is preferably then submitted to a rendering command stream for the GPU such that a frame can be generated, or rendered, by the GPU based on the generated predict token. The predict token may be indicative of an extrapolated or interpolated target frame to be generated for a sequence of frames and accordingly advantageously enables the GPU to generate an extrapolated and/or an interpolated frame without requiring the CPU-GPU roundtrip and the associated latencies and/or advantageously enables the GPU to generate, or render, a higher number of frames for the application executing on the CPU, thereby reducing latency and/or increasing the frame rate, e.g. the number of frames per second (fps).

The application executing on the host processor (CPU) may communicate with the driver via one or more Application Programming Interface (API) extensions to provide the commands and/or parameters in relation to generating the predict token for the GPU rendering command stream. For example, the application may generate one or more predict tokens and provide the one or more predict tokens to the driver to submit to the rendering command stream, or the application may provide one or more performance requirements (e.g. in relation to latency, frames per second, resolution, power usage, and so on) to the driver such that the driver can generate the one or more predict tokens to be submitted to the rendering command stream as required to fulfil, or substantially fulfil, the received, or set, performance requirements.

The number and frequency of the predict tokens in the rendering command stream may be dependent on the one or more performance requirements for frame rendering, wherein the performance requirements may include, one or more of latency, frames per second, resolution, and power usage, or any other performance requirements for the frame rendering for an XR display system. The application and/or the driver executing on the host processor (CPU) may monitor the one or more performance requirements and take action to generate one or more predict tokens based on the one or more monitored performance requirements.

For example, the performance requirement may relate to the number of frames per second (fps), e.g. 60 fps, so that the application and/or the driver monitors the current frames per second and, if the performance requirement is not met (e.g. by comparison of the current fps to the required fps) the application and/or driver may generate one or more predict tokens in order to increase the number of frames per second. The frames per second may be below the respective performance requirement due to, for example, the scene being rendered is more complex and therefore more processor intensive to render the frames of the scene thereby reducing the number of frames per second being rendered. Generating, or rendering, a frame based on the predict token by the GPU is less processor intensive and therefore generating predict tokens for the rendering command stream of the GPU can be used to increase the number of frames per second.

In another example, the performance requirement may relate to latency, wherein for XR display systems a high latency can cause significant performance issues. Thus, the current latency may be monitored, e.g. comparing the current latency to the required latency performance requirement, and if the latency is close to, at, or above, the latency performance requirement, one or more predict tokens to be submitted to the rendering command stream in the appropriate position in the sequence of frames. In a further example, the performance requirement may relate to power usage, wherein for XR display systems that include, for example, mobile devices, there is a limited power supply via the mobile device battery, and as such a reduction in battery use may be achieved by implementing the predict token, e.g. via less intensive processing requirements. Additionally, if a device consumes too much power, then it may become hot leading to a thermal throttle which degrades the performance of the device due to over-heating which can lead to any of the performance requirements not being met. This is relevant to mobile devices as mobile devices typically include only limited heat exchange with no additional cooling, e.g. via fans. Thus, by implementing the less processor intensive predict token from which a frame can be generated, or rendered, both the thermal and battery performance of the mobile device can be improved.

As will be appreciated, any, or any combination, of the one or more performance requirements may be utilised and/or monitored in the determination of when to generate a predict token for the rendering command stream in order to improve the performance of the XR display system.

The application and/or the driver may, based on the frames being, to be, or have been rendered, determine, or identify, information relating to the frames, for example, the information may include or more of processing operations (e.g. motion vector processing), commands, data, and parameters, or any other relevant information relating to the frames as required. Thus, the application and/or driver may utilise the information to determine, or identify, the position in the sequence of frames at which to include a predict token, the type of predict token to be used (e.g. extrapolation or interpolation), and/or the data/parameters to include in (e.g. populate) the predict token data structure.

The predict token preferably references a predict command buffer and a predict parameter buffer. As will be appreciated, the predict token may reference any number of buffers, commands, and/or parameters as required to enable the GPU to generate, or render, frames with a low latency, low bandwidth requirements, and/or a higher frame rate than the traditional approach described hereinabove.

The application executing on the CPU and/or the driver may generate, or define, the command(s) added to the predict command buffer for the target frame to be generated by the GPU, wherein the command(s) are operable to instruct the GPU, once executed by the GPU, to perform one or more operations and/or to provide information, or data, relating to the frame to be generated by the GPU based on the predict token. For example, the predict command buffer may include one or more variables, command(s), and/or instruction(s) relating to, e.g., predict parameter sampling, predict parameter compute, and predict frame generation. The predict command buffer may therefore preferably define the type of predict token (e.g. extrapolation or interpolation), the frames on which the target frame of the predict token is to be generated, and command(s), or instruction(s), to execute any required data sampling and/or compute jobs, in order for the GPU to generate the target frame based on the predict token. As will be appreciated, the predict command buffer may include any number of variables, commands, instructions, and/or data in order for the GPU to generate the target frame based on the predict token.

The application and/or the driver may populate the predict parameter buffer with any data, or information, for one or more parameters of the predict parameter buffer that is/are available to the application at the time the predict token is generated, or defined, by the application and/or the driver. For example, data relating to motion vectors, global motion (e.g. motion of the camera in the scene), and so on may be populated if the application and/or the driver can determine or obtain the data at the time of generating the predict token. The predict parameter buffer therefore includes one or more predict parameters required to generate the target frame based on the predict token and, as will be appreciated, the parameters included in the predict parameter buffer, along with any memory allocation for the predict token, may depend upon the type of predict token (e.g. extrapolation or interpolation) and/or the processing, or operations, to be performed on the preceding and/or subsequent frames, on which the target frame will be based, in the sequence of frames representing the scene being rendered.

One or more further parameters of the predict parameter buffer, where the data is not available to the application at the time the predict token is generated, or defined, by the application, may be left blank, or empty by the application and/or driver on generating the predict token. For example, where such further parameters rely on data from previous (or preceding) or subsequent rendered frames. The further parameters that may be left blank, or empty, can be populated by the GPU when executing the predict token in order to process (or generate) a target frame based on the predict token. In other words, the GPU may perform the necessary processing, or operations, to obtain the data relating to the further parameters. For example, the predict token may include, for example, in the predict command buffer, a sampling command to obtain data, e.g. sensor data, a command to compute data based on the obtained data, and a command to generate data.

This is advantageous as it removes the inherent latencies associated with the CPU-GPU roundtrip, as the GPU directly and (substantially) in real-time can determine the further parameters when generating the frame associated with the predict token. The further parameters may relate to, but not limited to, one or more of motion vectors, frame buffer, z-buffer, rotation, and so on, from the preceding or subsequent frames. For example, if the target frame for which the predict token is defined requires rotation, which may be dependent upon the preceding and/or subsequent frame and thus could not be populated by the application and/or driver on generating the predict token, the predict command buffer may include a predict parameter sampling command to be executed to obtain the rotation data, e.g. from one or more raw sensor data, a predict parameter compute command to be executed to compute and transfer the rotation data to a matrix format and populate this matrix (rotation) data into the relevant parameter(s) of the predict parameter buffer, and a predict frame generation command to be executed to generate the target frame based on the type of predict frame (e.g. interpolation/extrapolation) and the rotation data in the predict parameter buffer.

The predict parameter buffer may include one or more parameters, wherein the parameters may indicate, or define, one or more buffers, one or more operations, one or more pointers to data for the target frame to be generated by the GPU based on the predict token, and so on. For example, the predict parameter buffer may include a buffer with a pointer to motion vector estimation data, a matrix with a pointer to rotation data, and so on. As will be appreciated, the predict parameter buffer may include any number of parameters relating to the data required by the GPU to generate, or render, a frame based on the predict token.

In pseudocode, the predict token may be defined as:
typedef predict_token_template{
   Struct predict_command{
      predict_parameter_sampling (enum predict_parameter_type, *predict_parameter_sampling_command, *predict_parameter_buffer);
      predict_parameter_compute (enum predict_parameter_type, emum predict_compute_type, *predict_parameter_compute_command, *predict_parameter_buffer);
      predict_frame_generation (emum predict_parameter_type, emum predict_frame_generation_type, emum predict_frame_compute_type, *predict_frame_generation_command, *predict_parameter_buffer);
}
   Struct predict_parameter_buffer{
      Buffer *MVE;
      Matrix *Rotation;
      . . .
   }
} predict_token_template;
The predict parameter sampling command may include a predict parameter type, along with pointers to a predict parameter sampling command, wherein the predict parameter sampling command, once executed, instructs the GPU to obtain, or sample, the required data for the given predict token, and a pointer to the predict parameter buffer.

The predict parameter type preferably includes an indication of the parameter type, for example, one or more of motion vector estimation, translation, position difference, rotation, zoom in, zoom out, reprojection, shift, 3D model, or any other relevant parameter type. In pseudocode, the predict parameter type may be defined as:
typedef enum{
MOTION_VECTOR_ESTIMATION=0;
TRANSLATION=1;
POSITION_DIFF=2;
ROTATION=3;
ZOOM_IN=4;
ZOOM_OUT=5;
REPROJECTION=6;
SHIFT=7;
3D_MODEL=8;
. . .
}predict_parameter_type;

The predict parameter compute command may include the predict parameter type, and a predict compute type, along with pointers to a predict parameter sampling command and a pointer to the predict parameter buffer.

The predict compute type preferably includes an indication of the compute type, or compute job, that the GPU is to perform on executing the command, for example, one or more of a motion vector compute, a reprojection compute, a 3D model compute, or any other relevant compute type. In pseudocode, the predict compute type may be defined as:

typedef enum{
MOTION_VECTOR_COMPUTE=0;
REPROJECTION_COMPUTE=1;
3D_MODEL_COMPUTE=2;
. . .
}predict_compute_type;

The predict frame generation command may include the predict parameter type, a predict frame generation type, and a predict frame compute type, along with a pointer to a predict frame generation command and a pointer to the predict parameter buffer.

The predict frame generation type preferably includes an indication of the frame generation type, for example, by interpolation or by extrapolation. In pseudocode, the predict frame generation type may be defined as:
typedef enum{
INTERPOLATION=0;
EXTRAPOLATION=1;
}predict_frame_generation_type;

The predict frame compute type preferably includes an indication of the compute job(s), or operations, that are to be processed, or performed, to generate the frame by the GPU based on the predict token. For example, the indication(s) may include one or more of Asynchronous Time Warp (ATW), Asynchronous Space Warp (ASW), Asynchronous Reprojection (ARP), Translation (e.g. 2D image translation), Lens Matched Shading (LMS), Variable Rate Shading (VRS), Fragment Density Map (FDM), Foveated Rendering, Partial Frame Processing, Motion Estimation and Optical Flow, Super Resolution, Framerate Upscaling, or an indication of any other processing. In pseudocode, the predict frame compute type may be defined as:

typedef enum{
MOTION_VECTOR_ESTIMATION=0;
VR_ATW=1;
VR_ASW=2;
TRANSLATION=3;
LMS=4;
VRS=5;
FDM=6;
FOVEATED=7;
3D_MODEL_ESTIMATION=8;
OPTICAL_ESTIMATION=9;
ARP=10;
. . .
}predict_frame_compute_type;

The pointer to the predict frame generation command, refers the GPU to a command list for the generation (or rendering) of the target frame of the scene, and may include, or point to, the predict parameter buffer as an input to the rendering pipeline of the GPU (wherein the predict parameter buffer includes the relevant parameters for the rendering of the target frame dependent on the target frame being rendered, for example, a reprojection rotation matrix), and commands to render, or generate, the target frame.

In embodiments, the predict command buffer and the predict parameter buffer may be stored in a memory, (e.g. a main memory and/or a cache memory) that is local to, or separate from, the graphics processing unit. In embodiments, a reference (e.g. a pointer) to an address of a location in the memory at which the predict command buffer and the predict parameter buffer may reside may be included in the predict token. The predict token may, in embodiments, include, or be, an instruction (e.g. a Command Stream Frontend instruction) wherein the instruction opcode(s) may include one or more commands of the predict command buffer and/or one or more parameters of the predict parameter buffer. Additionally, or alternatively, in embodiments the instruction may include one or more registers, wherein the one or more registers may indicate, or reference, an address (e.g. location) in memory of the predict command buffer and the predict parameter buffer and/or the one or more registers may be populated, or loaded, with one or more commands and/or parameters from the predict command buffer and the predict parameter buffer prior to execution of the predict token.

In embodiments, the predict token described above is utilised by the GPU to generate a target frame (e.g. an extrapolated frame and/or an interpolated frame). The predict token in the command stream submitted to the driver of the GPU by the application executing in the CPU may instruct, or indicate to, the GPU the type of frame to generate, or render, e.g. extrapolated or interpolated frame.

If the GPU, on reading, or executing, the predict token in the command stream, identifies, or determines, an extrapolated frame is to be generated the GPU extrapolates a target frame (e.g. Fn+1) based on a first frame (e.g. Fn) and a second frame (e.g. Fn−1) of a sequence of frames for display. In relation to extrapolating the target frame (e.g. Fn+1), the first and second frames are prior to, or precedes, the target frame and preferably the two (or more) frames immediately prior, or preceding, to the target frame, e.g. Fn and Fn−1. In embodiments, the GPU executes the predict command(s) provided in the predict command buffer and reads the parameters provided in the predict parameter buffer of the associated predict token.

In order to generate an extrapolated target frame, the image represented by the extrapolated frame will likely have changed in comparison to the image represented by the first frame and the second frame. As such, the extrapolated frame may require one or more processing, or compute, operations to be performed, e.g. ATW, ASW, MVE, and so on. As discussed above, and in relation to FIG. 2, in the traditional approach this would require the application executing on the CPU to perform several operations which introduces significant latencies, e.g. caused by the CPU-GPU roundtrip. In the embodiments, the GPU, based on the predict token, can directly perform the required processing, or compute, operations to obtain the data required for generating, or rendering, the extrapolated frame. The data obtained from the processing, or compute, operations by the GPU can be used, in embodiments, to populate any parameters of the predict parameter buffer which were not populated by the application executing on the CPU at the time the predict token was generated, or defined, by the application. For example, the GPU may perform sampling, e.g. movement sampling, including, for example, one or more of sampling for translation, position, rotation, zoom in/out, and so on, along with any number of required processing, or compute, operations, including, for example, one or more of reprojection, ATW/ASW, image transformation, shift, motion vector estimation. The results of the sampling and any processing, or compute, operations, are used to populate the predict parameter buffer to then enable the GPU to generate the extrapolated frame.

If the GPU, on reading, or executing, the predict token in the command stream, identifies, or determines, an interpolated frame is to be generated, or rendered, the GPU interpolates a target frame (e.g. Fn+2a) based on a first frame (e.g. Fn+2) and a second frame (e.g. Fn+3) of a sequence of frames for display. In relation to interpolating the target frame (e.g. Fn+2a) the first frame (e.g. Fn+2) is prior to, or preceding, the target frame (e.g. Fn+2a) and the second frame (e.g. Fn+3) is subsequent to the target frame (e.g. Fn+2a). Preferably, the first frame and the second frame are adjacent to the target frame. In embodiments, the GPU executes the predict command(s) provided in the predict command buffer and reads the parameters provided in the predict parameter buffer of the associated predict token.

As discussed above, the traditional approach, as shown in FIG. 2, may suffer from a low frame rate (e.g. a low frames per second (fps)), due to host processor (CPU) processing capability, graphics processing unit (GPU) processing capability, memory bandwidth, and/or limited power availability, e.g. for mobile devices and/or headsets, which cannot therefore achieve the required frame rate due to a heavy rendering overload (e.g. the processing required) to render each and every frame at high frame rates.

The Applicants have recognised that the predict token may, in one or more embodiments, advantageously be utilised by the graphics processing system to increase the frame rate. The use of the predict token in the generation of interpolated frames, may increase the frame rate, for example, by a factor of two, three, four, and so on, depending on the number of interpolated frames that are inserted into the sequence of frames for display.

In order to generate an interpolated target frame, the image represented by the interpolated frame will likely be different to the image represented by the first frame and the second frame. As such, the interpolated frame may require one or more processing, or compute, operations to be performed, e.g. MVE, and so on.

In the embodiments, the GPU, based on the predict token, can directly perform the required processing, or compute, operations to obtain the data required for generating, or rendering, the interpolated frame. The data obtained from the processing, or compute, operations by the GPU can be used, in embodiments, to populate any parameters of the predict parameter buffer which were not populated by the application executing on the CPU at the time the predict token was generated, or defined, by the application. For example, the GPU may perform sampling, e.g. movement sampling, including, for example, one or more of sampling for translation, position, rotation, zoom in/out, and so on, along with any number of required processing, or compute, operations, including, for example, motion vector estimation. The results of the sampling and any processing, or compute, operations, are, in embodiments, used to populate the predict parameter buffer to then enable the GPU to generate the interpolated frame.

FIG. 3 shows a schematic of an exemplary arrangement according to one or more embodiments of the present disclosure. In embodiments, the application 10 executing on the CPU 7 submits appropriate commands and data to a driver, wherein the driver is executing on the CPU 7, for the graphics processing unit (GPU) 2. The driver will then generate appropriate commands and data which are submitted to a rendering command stream 12 in the form of a predict token to cause the graphics processing unit (GPU) 2 to render appropriate frames for display.

The GPU is able to render 17 frames Fn−1 and Fn based on the commands and data submitted to the rendering command stream 12, as frames Fn−1 and Fn do not require additional processing operations, such as ATW/ASW, and so on, therefore are standard rendered frames as performed in conventional display system. However, frame Fn+1 does require additional processing operations as the frame to be rendered involves, in this example, ATW/ASW processing operations. However, as will be appreciated, the embodiments of the present disclosure are equally applicable to other additional processing options, including, but not limited to, Asynchronous Reprojection (ARP) which may also be referred to as Motion-to-Photon (MTP), Translation, Lens Matched Shading (LMS), Variable Rate Shading (VRS), Fragment Density Map (FDM), Foveated Rendering, Partial Frame Processing, Motion Estimation and Optical Flow, Super Resolution, and Framerate Upscaling.

As discussed in relation to FIG. 2, the traditional approach would require a CPU-GPU roundtrip, which included several operations being performed by the application executing on the CPU, for example, a context switch, a read of frame Fn from memory, build the Fn+1 ATW/ASW commands, and a submission of the Fn+1 ATW/ASW commands to the GPU via the driver, which introduced a number of latencies causing a long latency between the rendering of frames Fn and Fn+1.

Returning to FIG. 3, in embodiments, the present disclosure enables a low latency 19 between the rendering, or generation, of frames Fn and Fn+1 due to the implementation of the predict token 18 which is processed by the GPU 2 directly in order to generate frame Fn+1. The GPU executes the predict token 20 that was defined by the application 10 executing on the CPU 7 and submitted to the rendering command stream 12, determining that frame Fn+1 will be extrapolated, as indicated by a predict command within the predict command buffer of the predict token, based on frames Fn and Fn−1, identifying the additional processing operations required to generate, or render, the extrapolated frame Fn+1, e.g. ATW/ASW, and performs, directly and (substantially) in real-time, the processing operations in order to generate the extrapolated frame Fn+1. In embodiments, the GPU preferably re-uses frames Fn and Fn−1/pixels along with frame Fn's rendering commands in generating the extrapolated frame Fn+1. For example, if the difference between a target frame and the preceding frame(s) is a only a horizontal scroll move then this will transfer to a horizontal pixel move for the target frame. Thus, the pixels may be read, or obtained, from the preceding frame(s) and shifted by an offset according to the horizontal pixel move without the need, or requirement, of processing those pixels, e.g. re-shading the pixels. As a further example, rendering commands relating to the pixels of preceding frame(s) may be re-used, e.g. if there is only a viewport change then there will be no change to the rendering pipeline and as such the rendering pipeline (e.g. rendering commands) of the preceding frame(s) can be re-used with a dynamic state (e.g. viewport) change in the target frame.

As described above, in embodiments the graphics processing unit 2 can include, and in embodiments does include, any one or more, and in embodiments all, of the processing stages that a graphics processing unit can normally include, e.g. a programmable execution unit operable to execute (shader) programs to perform processing operations, a rasteriser, a renderer (wherein the rendering approach may include, for example, raytracing, hybrid raytracing, or any other suitable rendering approach), and so on. Accordingly, the GPU 2, when executing the predict token 20 to extrapolate frame Fn+1, preferably utilises one or more of the processing stages of the GPU to perform one or more processing operations, e.g. sampling, compute jobs, and so on, to compute, or determine, one or more parameters for the extrapolated frame and to populate the predict parameter buffer with the necessary data for the GPU to subsequently generate the extrapolated frame Fn+1.

Returning to FIG. 3, frame Fn+2 is rendered by the GPU based on the commands and data provided by the application and/or driver executing on the CPU in the command. However, to increase the frame rate (the frames per second fps), the application and/or driver executing on the CPU submits a predict token 18 to the rendering command stream 12. The GPU on executing the predict token identifies, or determines, based on a predict command within the predict command buffer of the predict token that a frame Fn+2a is to be interpolated based on frames Fn+2 and Fn+3. The GPU then renders 17 frame Fn+3 based on the commands and data provided by the application executing on the CPU in the command. Once both of the frames Fn+2 and Fn+3 have been rendered by the GPU, the GPU can subsequently generate the interpolated frame Fn+2a based on the rendered frames Fn+2 and Fn+3. On executing the predict token 21 to generate frame Fn+2a, the GPU may further identify any additional processing operations required to generate the interpolated frame Fn+2a, e.g. MVE, from a predict command within the predict command buffer, and performs, directly and (substantially) in real-time, any processing operations in order to generate the interpolated frame Fn+2a. The GPU preferably re-uses frames Fn+2 and Fn+3 pixels along with frame Fn+2s rendering commands in generating the interpolated frame Fn+2a.

As described above, in embodiments the graphics processing unit can include, and in embodiments does include, any one or more, and in embodiments all, of the processing stages that a graphics processing unit can normally include, e.g. a programmable execution unit operable to execute (shader) programs to perform processing operations, a rasteriser, a renderer (wherein the rendering approach may include, for example, raytracing, hybrid raytracing, or any other suitable rendering approach), and so on. Accordingly, the GPU, when executing the predict token to interpolate frame Fn+2a, preferably utilises one or more of the processing stages of the GPU to perform one or more processing operations, e.g. MVE, and so on, to compute, or determine, one or more parameters for the interpolated frame and to populate the predict parameter buffer with the necessary data for the GPU to subsequently generate the target interpolated frame Fn+2a.

By interpolating frame Fn+2a based on the submitted predict token, the graphics processing system is able to render/generate frames at a higher frame rate 22 than the conventional graphics processing systems, as described above in relation to FIG. 2.

FIG. 4 shows a schematic of an exemplary arrangement according to one or more embodiments of the present disclosure. In embodiments, the application 10 executing on the CPU 7 submits appropriate commands and data to a driver, wherein the driver is executing on the CPU 7, for the graphics processing unit (GPU). The driver will then generate appropriate commands and data that are submitted to the rendering command stream 12 to cause the graphics processing unit (GPU) to render 17 appropriate frames for display 14.

The GPU 2 renders 17 frames Fn−1 and Fn based on the commands and data received via the rendering command stream 12, as frames Fn−1 and Fn do not require additional processing operations, such as ATW/ASW, and so on, as described above in relation to FIG. 3. On identifying the predict token 18 for frame Fn+1, the GPU executes the predict token, and determines, or identifies, from a predict command in the predict command buffer of the predict token, that frame Fn+1 is to be an extrapolated frame based on the previous frames Fn and Fn−1. The GPU also executes any required processing operations in order to determine one or more parameters, in real-time and directly on the GPU, to populate any parameters of the predict parameter buffer that the application and/or driver executing on the CPU was unable to populate at the time of generating, or defining, the predict token. For example, such parameters may require the previous frames to have been rendered prior to the generation of the extrapolated frame Fn+1. As shown in FIG. 4, the GPU 2 may, in embodiments, perform one or more processing operations, including, but not limited to, movement sampling 23 (e.g. translation, position, rotation, zoom in/out, and so on), motion vector estimation (or generation) via a motion vector engine to determine, or calculate, a motion vector based on frames Fn−1 and Fn (which may, in embodiments, include the use of a Motion Vector Engine 24 to calculate or estimate a motion vector 25), and so on, based on the predict commands provided in the predict command buffer of the predict token. The results of the one or more processing operations defined, or indicated, by one or more predict commands in the predict command buffer of the predict token, are used to populate the one or more parameters of the predict parameter buffer of the predict token. The GPU may also perform one or more further processing operations including, but not limited to, reprojection 26, ATW/ASW compute 27, image transformation 28, shift 29, and so on, the results of which may also be used to populate the relevant, or corresponding, parameter of the predict parameter buffer, or be fed directly into the generation of the extrapolated frame 30.

The GPU then performs the frame extrapolation 30, based on the data stored in the populated predict parameter buffer, and/or the results of the one or more further processing operations, based on the commands defined in the predict command buffer, to generate frame Fn+1. By extrapolating frame Fn+1 directly and in real-time on the GPU, this enables the GPU to render frame Fn and generate frame Fn+1 with a (ultra) low latency therebetween, in contrast to the traditional approach shown in FIG. 2 which required a CPU-GPU roundtrip and the application executing on the CPU to perform several operations which caused a significant latency between frame Fn being rendered and frame Fn+1 being generated.

The GPU renders 17 frame Fn+2 based on the commands and data received via the rendering command stream 12, as frame Fn+2 does not require additional processing operations for the GPU to render the frame and can be rendered 17 based on the commands and data supplied by the application executing on the CPU.

In relation to frame Fn+2a, the GPU identifies the predict token 18 for frame Fn+2a, and, based on a predict command in the predict command buffer of the predict token, the GPU identifies, or determines, that frame Fn+2a is to be an interpolated frame based on the previous frame Fn+2 and the subsequent frame Fn+3. The GPU then renders 17 the subsequent frame Fn+3 as frame Fn+3 does not require additional processing operations for the GPU to render the frame and can be rendered based on the commands and data supplied by the application executing on the CPU via the rendering command stream 12.

On completion of the GPU rendering frame Fn+3, the GPU generates the interpolated frame Fn+2a. The GPU executes any required processing operations in order to determine one or more parameters, in real-time and directly on the GPU, to populate any parameters of the predict parameter buffer that the application and/or driver executing on the CPU was unable to populate at the time of generating, or defining, the predict token. For example, such parameters may require the previous and subsequent frames to have been rendered prior to the generation of the interpolated frame Fn+2a. As shown in FIG. 4, the GPU may, in embodiments, perform one or more processing operations, including, but not limited to, motion vector estimation (which may, in embodiments, use the Motion Vector Compute Engine 24 to determine, or calculate, a motion vector 25) based on frames Fn+2 and Fn+3. The results of the one or more processing operations defined, or indicated, by one or more predict commands in the predict command buffer of the predict token, are used to populate the one or more parameters of the predict parameter buffer of the predict token. The GPU may also perform one or more further processing operations as required, the results of which may also be used to populate the relevant, or corresponding, parameter of the predict parameter buffer, and/or be used directly in the generation of the interpolated frame 31.

The GPU then performs the frame interpolation, i.e. generates the interpolated frame, 31 based on the data stored in the populated predict parameter buffer and based on the commands defined in the predict command buffer, to generate frame Fn+2a By interpolating frame Fn+2a using the predict token, enables the GPU to increase the frame rate (frames per second (fps)), and depending on the number of interpolated frames, the frame rate can advantageously be doubled, tripled, quadrupled, and so on.

FIG. 5 is a flow chart of the operation of the graphics processing system according to one or more embodiments of the present disclosure. In step 32 an application executing on a host processor (CPU) submits a predict token to a rendering command stream for a graphics processing unit (GPU), wherein the predict token, in embodiments, references a predefined command buffer and a predict parameter buffer. In embodiments, the predefined command buffer includes one or more predict commands. In embodiments, the application executing on the CPU may populate one or more parameters of the predict parameter buffer with data that is known to the application at the time of generating, or defining, the predict token. Further parameters, for which the data is not known to the application at the time of generating, or defining, the predict token are left unpopulated.

In step 33, the GPU identifies the predict token in the rendering command stream among the commands and data relating to one or more other frames of a sequence of frames to be rendered by the GPU.

In step 34, on identifying a predict token, the GPU preferably determines a new target frame generating type, for example, whether the new target frame generating type is extrapolation or interpolation, based on a predict command in the predict command buffer of the predict token.

If the target frame generating type is extrapolation, the GPU preferably executes the predict commands in the predict command buffer of the predict token in step 35. In step 36 any parameters not populated by the application at the time of generating, or defining, the predict token are (directly) populated by the GPU in real-time utilising the results of one or more of the executed predict commands. In embodiments, GPU may perform sampling and/or compute operations to determine, or calculate, the data for the parameters, wherein the parameters are required to generate the required extrapolated target frame Fn+1. In step 37 the target frame defined by the predict token is generated by extrapolation based on at least one previous frame Fn, preferably at least two previous frames Fn and Fn−1, and preferably wherein at least one of the previously frames is a rendered frame.

If the target frame generating type is interpolation, the GPU preferably executes the predict commands in the predict command buffer of the predict token in step 38. In step 39 any parameters not populated by the application at the time of generating, or defining, the predict token are (directly) populated by the GPU in real-time utilising the results of one or more of the executed predict commands. In embodiments, GPU may perform sampling and/or compute operations to determine, or calculate, the data for the parameters, wherein the parameters are required to generate the interpolated target frame Fn. In step 40 the target frame defined by the predict token is generated by interpolation based on at least one previous frame Fn−1 and at least one subsequent frame Fn+1, and preferably wherein at least one of the previous frame and/or the subsequent frame is a rendered frame.

In step 41 the generated frame is stored in appropriate frame buffers, e.g. in the main memory. The display controller will then read those frames into a buffer for the display from where they are then read out and displayed on the display panel of the display.

In embodiments of the method, the predict parameters of the predict parameter buffer of the predict token may include, but not limited to, one or more of the following a motion vector, a translation, a position difference, a rotation, a zoom in/out, a reprojection, a shift, a 3D estimation, and so on. In embodiments of the method, the predict token may define the target frame generating type, including, but not limited to, interpolation and extrapolation, and one or more processing operations including, but not limited to, Motion Vector Estimation MVE, Asynchronous Reprojection ARP, Asynchronous Time Warp ATW, Asynchronous Space Warp ASW, Lens Matched Shading LMS, Variable Rate Shading VRS, Fragment Density Map FDM, foveated rendering, optical flow estimation, and so on.

The application and/or the driver executing on the host processor may generate the data structures referenced by the predict token, e.g. the predict command buffer and the predict parameter buffer, for the target frame and, in embodiments, writes the data structures to a memory. In one or more embodiments, the GPU may include a Job Control (JC) unit relating to, or operating as, a Command Stream Frontend (CSF). The CSF may configure and/or control the operation of the GPU and to indicate a location in memory that received instruction(s) and/or command(s) reside in a memory associated with the GPU, wherein the CSF may be controlled directly by the host processor (CPU). In embodiments, the CSF includes a hardware interface (HWIF) which, once the GPU is configured, can fetch the instructions and/or commands from the memory to be executed. The CSF may, in embodiments, further include a Micro-Controller Unit (MCU), wherein the MCU of the CSF is a processor that executes software (preferably firmware). Accordingly, less complex CSF HWIF functions (e.g. instructions/commands) may be executed directly by the HWIF in hardware, whereas more complex CSF HWIF functions (e.g. instructions/commands) can be transmitted, or passed, by the CSF HWIF to the MCU to be executed in software, wherein the MCU may transmit appropriate jobs to other units (e.g. programmable executable units, memory, and so on) for execution.

Conventional graphics processing systems may include a CSF instruction set to execute graphics data processing, e.g. by the CSF HWIF in hardware and/or by CSF MCU in software (e.g. firmware) utilising the GPU units, e.g. programmable executable units (e.g. shader cores), to execute instructions/commands relating to the graphics pipeline. In the present technique, the CSF may, in embodiments, be expanded to include instructions relating to the generating, or rendering, of a target frame based on the predict token submitted to the rendering command stream. Thus, the CSF instruction set may be expanded to include an instruction, e.g. RUN_PREDICT, to enable the CSF to execute the predict token. In embodiments, the additional CSF instruction, e.g. RUN_PREDICT, may include one or more registers, one or more opcodes defining, or indicating, one or more parameters relating to the predict token, for example, the type of prediction (e.g. extrapolation/interpolation), and may also include one or more pointers to data relating to the predict token, e.g. to motion vectors, frame buffers, z-buffer, etc., relating to preceding and/or subsequent frame(s). The CSF HWIF/MCU interprets the additional instruction, e.g. RUN_PREDICT, and executes the additional instruction, utilising any registers, parameters and/or pointers, associated with the additional instruction and transmits, or sends, the relevant commands of the predict token to the relevant unit of the GPU, as required, in order to execute the predict token and generate, or render, the target frame. In embodiments, the entire instruction relating to the predict token may be executed by the CSF HWIF in hardware, or the instruction may be passed to the CSF MCU for the additional instruction to be processed in software, e.g. firmware.

Although the technology described herein has been described above with particular reference to generating a single extrapolated frame and/or a single interpolated frame, it will be appreciated that plural extrapolated and/or interpolated frames may be generated (and displayed on a display). For example, plural extrapolated and/or interpolated frames (e.g. two, three, four, eight, etc. extrapolated and/or interpolated frames) may be generated.

Similarly, when the graphics processing system comprises a head mounted display there may be an extrapolated and/or interpolated frame generated for each eye, and a respective extrapolated and/or interpolated frame may be displayed to each eye appropriately so as to provide a three-dimensional effect when the images are viewed.

Correspondingly, the technology described herein is in an embodiment applied to a plurality of (rendered or generated) frames, and in an embodiment to a plurality of (rendered or generated) frames that are being generated as a sequence of frames for display.

The technology described herein is in an embodiment implemented in and as part of an overall graphics processing system that includes one or more of: a host processor (central processing unit (CPU)), a graphics processing unit, a display controller, a system bus, and a memory controller.

The processing circuit(s) of the technology described herein may, e.g., form part of the graphics processing unit, the display controller and/or another suitable component of the graphics processing system, e.g. as described above, or may otherwise be provided in the graphics processing system. It may comprise programmable and/or fixed function processing circuit(s), and/or may comprise dedicated processing circuit(s) and/or processing circuit(s) used for other processing as well, as desired.

The host processor (CPU) may execute applications that can require graphics processing by the graphics processing unit, and send appropriate commands and data to the graphics processing unit to control it to perform graphics processing operations and to produce graphics processing (render) output required by applications executing on the host processor (including in the manner of the technology described herein).

To facilitate this, the host processor should, and in an embodiment does, also execute a driver for the graphics processing unit and a compiler or compilers for compiling shader programs to be executed by programmable shading stages of the graphics processing unit (which compiler may be, and in an embodiment is, a part of the driver).

Thus, in an embodiment, the graphics processing unit is in communication with a host processor (that is part of the overall graphics processing system) that executes a driver for the graphics processing unit and/or a compiler or compilers for the graphics processing unit.

Similarly, there is, in an embodiment, an application on the host processor that indicates a requirement for performing processing operations in the manner of the technology described herein, which requirement is then recognised by, e.g., the driver executing on, the host processor, with the, e.g. driver on, the host processor then operating to instruct the graphics processing unit to generate data accordingly.

The graphics processing unit and/or host processor are, in an embodiment, also in communication with a (head mounted) display for displaying the images generated by the graphics processing unit (thus, in an embodiment, the graphics processing system further comprises a display for displaying the images generated by the graphics processing unit) (e.g. via the display controller).

Similarly, in an embodiment, the graphics processing system has or is in communication with a memory in which frames (images) generated by the graphics processing unit may be stored, e.g. for subsequent processing, e.g. display (e.g. via the display controller). Thus, in an embodiment, the graphics processing system and/or unit comprises, and/or is in communication with, one or more memories and/or memory devices that store the data described herein, and/or that store software for performing the processes described herein.

The graphics processing unit can include, and in an embodiment does include, any one or more, and in an embodiment all, of the processing stages that a graphics processing unit can normally include. Thus, for example, in an embodiment the graphics processing unit includes one or more programmable execution units (e.g. shaders), a rasteriser and a renderer. In an embodiment the renderer is in the form of or includes a programmable fragment shader.

The graphics processing unit is, in an embodiment, a tile-based graphics processing unit comprising a tile buffer for storing tile sample values and/or a write out unit that operates to write the data in the tile buffer (e.g. once the data in the tile buffer is complete) out to external (main) memory (e.g. to a frame buffer).

It will be appreciated by those skilled in the art that all of the described embodiments of the technology described herein can, and in an embodiment do, include, as appropriate, any one or more or all of the features described herein.

The technology described herein can be implemented in any suitable system, such as a suitably configured micro-processor based system. In an embodiment, the technology described herein is implemented in a computer and/or micro-processor based system.

The technology described herein is, in an embodiment, implemented in a portable device, such as a mobile phone, tablet, smart glasses, and so on. The technology described herein is, in an embodiment, implemented in an HMD. Thus, another embodiment of the technology described herein comprises a virtual reality, mixed reality, and/or augmented reality display device comprising the graphics processing system of any one or more of the embodiments of the technology described herein.

Correspondingly, another embodiment of the technology described herein comprises a method of operating a virtual reality and/or augmented reality display device, comprising operating the XR display device in the manner of any one or more of the embodiments of the technology described herein.

The various functions of the technology described herein can be carried out in any desired and suitable manner. For example, the functions of the technology described herein can be implemented in hardware or software, as desired. Thus, for example, unless otherwise indicated, the various functional elements, stages and “means” of the technology described herein may comprise a suitable processor or processors, controller or controllers, functional units, circuits, processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuit(s), e.g., in the form of one or more fixed-function units (hardware) (processing circuit(s)), and/or in the form of programmable processing circuit(s) that can be programmed to perform the desired operation. Equally, any one or more of the processing stages and processing stage circuit(s) of the technology described herein may be provided as a separate circuit element to any one or more of the other processing stages or processing stage circuit(s), and/or any one or more or all of the processing stages and processing stage circuit(s) may be at least partially formed of shared processing circuit(s).

Subject to any hardware necessary to carry out the specific functions discussed above, the components of the graphics processing system can otherwise include any one or more or all of the usual functional units, etc., that such components include.

The methods in accordance with the technology described herein may be implemented at least partially using software, e.g. computer programs. It will thus be seen that in further embodiments the technology described herein comprises computer software specifically adapted to carry out the methods described herein when installed on a data processor, a computer program element comprising computer software code portions for performing the methods described herein when the program element is run on a data processor, and a computer program comprising code adapted to perform all the steps of a method or of the methods described herein when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD-ROM, RAM, flash memory, or disk.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD-ROM, ROM, RAM, flash memory, or hard disk. It could also comprise a series of computer readable instructions transmittable to a computer system, via a modem or other interface device, over a tangible medium, including but not limited to optical or analogue communications lines. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic or optical. It is contemplated that such a computer program product may be distributed as a removable medium with accompanying printed or electronic documentation, for example, shrink-wrapped software, preloaded with a computer system, for example, on a system ROM or fixed disk, or distributed from a server or electronic bulletin board over a network, for example, the Internet or World Wide Web.

The foregoing detailed description has been described with reference primarily to a sequence of rendered and generated frames. However, it will be understood that the process of motion estimation and motion compensation may be applied in the same manner to a sequence of decoded frames. For example, encoded video data may be decoded by a video engine to produce the sequence of encoded frames of video data that are then processed by the GPU as outlined above.

The foregoing detailed description has been presented for the purposes of illustration and description. It is not intended to be exhaustive or to limit the invention to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

What is claimed is:

1. A method of operating a graphics processing unit that renders a sequence of frames, the method comprising:
receiving a predict token via a rendering command stream for the graphics processing unit, wherein the predict token is indicative of an extrapolated or interpolated target frame to be generated for the sequence of frames;
executing the predict token;
generating the target frame for the sequence of frames based on the execution of the predict token; and
storing the generated target frame in a frame buffer.

2. The method of claim 1, in which the predict token references:
a predict command buffer, wherein the predict command buffer includes one or more predict commands defining one or more operations relating to the target frame to be generated by the graphics processing unit; and
a predict parameter buffer, wherein the predict parameter buffer includes one or more parameters that store data relating to the target frame to be generated by the graphics processing unit.

3. The method of claim 2, in which executing, by the graphics processing unit, the predict token, further comprises:
executing the one or more predict commands of the predict command buffer and populating one or more parameters of the predict parameter buffer based on one or more results of the execution of the one or more predict commands.

4. The method of claim 2, in which the one or more operations include one or more of Motion Vector Estimation MVE, Asynchronous Reprojection ARP, Asynchronous Time Warp ATW, Asynchronous Space Warp ASW, Lens Matched Shading LMS, Variable Rate Shading VRS, Fragment Density Map FDM, Foveated Rendering, and Optical Flow Estimation.

5. The method of claim 1, further comprising:
identifying, by the graphics processor unit, a predict frame generation type of the target frame to be generated, wherein the predict frame generation type includes extrapolation and/or interpolation; and
generating, by the graphics processor unit, the target frame according to the identified predict frame generation type.

6. The method of claim 5, in which if the predict frame generation type is identified as extrapolation, the target frame is generated based on a first frame of the sequence of frames and a second frame of the sequence of frames, wherein the first frame and the second frame precede the target frame.

7. The method of claim 6, in which if the predict frame generation type is identified as interpolation, the target frame is generated based on a first frame of the sequence of frames and a second frame of the sequence of frames, wherein the first frame precedes the target frame and the second frame is subsequent to the target frame.

8. The method of claim 2, in which the one or more parameters of the predict parameter buffer includes one or more of a motion vector, a translation, a position difference, a rotation, a zoom in/out, a reprojection, a shift, and a 3D estimation.

9. A graphics processing unit operable to render a sequence of frames;
wherein the graphics processing unit is operable to:
receive a predict token via a rendering command stream for the graphics processing unit, wherein the predict token is indicative of an extrapolated or interpolated target frame to be generated for the sequence of frames;
execute the predict token;
generate the target frame for the sequence of frames based on the execution of the predict token; and
store the generated target frame in a frame buffer.

10. The graphics processing unit of claim 9, in which the predict token references:
a predict command buffer, wherein the predict command buffer includes one or more predict commands defining one or more operations relating to the target frame to be generated by the graphics processing unit; and
a predict parameter buffer, wherein the predict parameter buffer includes one or more parameters that store data relating to the target frame to be generated by the graphics processing unit.

11. The graphics processing unit of claim 10, in which the graphics processing unit is further operable to:
execute the one or more predict commands of the predict command buffer and populate one or more parameters of the predict parameter buffer based on one or more results of the execution of the one or more predict commands.

12. The graphics processing unit of claim 10, in which the one or more operations include one or more of Motion Vector Estimation MVE, Asynchronous Reprojection ARP, Asynchronous Time Warp ATW, Asynchronous Space Warp ASW, Lens Matched Shading LMS, Variable Rate Shading VRS, Fragment Density Map FDM, Foveated Rendering, and Optical Flow Estimation.

13. The graphics processing unit of claim 9, in which the graphics processor unit is operable to:
identify a predict frame generation type of the target frame to be generated, wherein the predict frame generation type includes extrapolation and/or interpolation; and
generate the target frame according to the identified predict frame generation type.

14. The graphics processing unit of claim 13, in which if the predict frame generation type is identified as extrapolation, the graphics processing unit is operable to:
generate the target frame based on a first frame of the sequence of frames and a second frame of the sequence of frames, wherein the first frame and the second frame precede the target frame.

15. The graphics processing unit of claim 13, in which if the predict frame generation type is identified as interpolation, the graphics processing unit is operable to:
generate the target frame based on a first frame of the sequence of frames and a second frame of the sequence of frames, wherein the first frame precedes the target frame and the second frame is subsequent to the target frame.

16. The graphics processing unit of claim 10, in which the one or more parameters of the predict parameter buffer includes one or more of a motion vector, a translation, a position difference, a rotation, a zoom in/out, a reprojection, a shift, and a 3D estimation.

17. The graphics processing unit of claim 9, further comprising:
a command stream frontend, wherein the command stream frontend includes a hardware interface, the command stream frontend is operable to:
receive an instruction relating to an execution of the predict token; and
execute in hardware the received instruction to generate the target frame based on the predict token.

18. The graphics processing unit of claim 9, further comprising:
a command stream frontend, wherein the command stream frontend includes a micro-controller unit, the command stream frontend is operable to:
receive an instruction relating to an execution of the predict token; and
execute in software the received instruction to generate the target frame based on the predict token.

19. A method of generating a predict token, wherein the predict token is indicative of an extrapolated or interpolated target frame to be generated for a sequence of frames, comprising:
generating a predict command buffer, wherein the predict command buffer include one or more commands for generating a target frame for the sequence of frames;
generating a predict parameter buffer, wherein the predict parameter buffer includes one or more parameters for generating a target frame for the sequence of frames;
including one or more instructions that include a reference to a memory location of the generated predict command buffer and the generated predict parameter buffer in the predict token; and
submitting the generated predict token to a rendering command stream for a graphics processing unit.

20. The method of claim 19, further comprising:
determining one or more performance requirements;
monitoring the performance requirements; and
generating the predict token based on the monitored performance requirements.
